(19) United States
(12) Patent Application Publication
(10) Pub. No.: US 2019/0370454 A1
(43) Pub. Date: Dec. 5, 2019

(54) Individual Authentication Medium, Method for Producing Same, and Authentication System Using Same

(71) Applicant: KANKYO RESILIENCE CO., LTD, Yokohama-shi, Kanagawa (JP)

(72) Inventors: Hiroshi Nagasawa, Fujisawa-shi (JP); Junji Shikata, Ichikawa-shi (JP); Kiminori Itoh, Tokyo (JP)

(21) Appl. No.: 16/335,196

(22) PCT Filed: Oct. 2, 2017
(86) PCT No.: PCT/JP2017/035865

§ 371 Date: Mar. 20, 2019

(30) Foreign Application Priority Data
Sep. 30, 2016 (JP) 2016-194276

(51) Int. Cl. G06F 21/36; C03B 19/09; C03B 32/00; C03C 15/00; B42D 25/36; G06K 19/06; G06K 7/10

(52) U.S. Cl. CPC G06F 21/36; C03B 19/09; C03B 32/00; G06K 7/10722; B42D 25/36; G06K 19/06009; C03C 15/00

(57) ABSTRACT

In authentication of machineries and cards (artifact) that are used in social acts such as economic acts, an approach of artifact metrics corresponding to biometrics is effective. Therefore, the subject is to find out a material that satisfies requirements of artifact metrics and is, preferably, suppliable stably and also economically, to establish the production method thereof, and to apply these to an individual authentication system of artifact. Porous glass, which possesses a spinodal phase separation structure, is an individual authentication medium as artifact metrics. There is provided a production method thereof, and an individual authentication system utilizing the individual authentication medium.

### TECHNICAL FIELD

The present invention relates to an individual authentication medium, a method for producing the same, and an authentication system using the same, and in more particular, relates to an individual authentication medium applicable to an individual authentication of a substance and a method for producing the same, and an authentication system using the same.

### BACKGROUND ART

In practice of network environments and credit acts such as various commercial transactions and contracts in explosive spread of mobile devices or in an IoT (Internet of Things) community under the present circumstances, individual authentication is a basic requirement. For example, identification of an individual person in social life is the foundation in social acts such as economic acts, and, to vouch, individual authentication is conducted by biometrics such as a facial portrait or, finally, a fingerprint or an iris pattern. However, including various computers, mobile phones, machineries such as automobiles, and cards that are used in social acts such as economic acts do not have an ultimate individual authentication system in the present situation. That is, for example, when a SIM card of a smartphone that has just been stolen is replaced, it is difficult to prove that the smartphone is an original smartphone. Further, in an automatic driving car, too, individual discrimination is a technology that is the base of safe automatic driving.

For authentication of an artifact, an approach of a certification medium: artifact metrics, which corresponds to biometrics used for identification of an individual person, is effective. However, it is a major subject of this field to discover a material that satisfies requirements for artifact metrics with an ideal form.

Requirements for causing physical characteristics of certain artifact to be utilized as an artifact metrics element to materialize an artifact metric system include following four properties (see, for example, Non-Patent Literature 1).

Individuality

Properties that artifact metrics elements of respective individuals are recognized to be different sufficiently each other.

Stability of Readout (Stability)

Properties that information equivalent to information at registration can be read out stably when an artifact metrics element has been registered and then the artifact metrics element is read out again.

Durability (Stability)

Properties that information equivalent to information at registration can be read out stably from artifact metrics element having been changed/deteriorated caused by external factors associated with the utilization of the artifact.

Clone Resistance

Properties that production of a counterfeit (which is called a clone) tricking a readout device is extremely difficult.

When necessary conditions as an individual authentication medium are considered, first, the individuality is absolutely necessary. This is a property that artifact metrics elements of respective individuals are recognized to be different sufficiently from each other, and, to establish the individuality, a randomness property such as a table of random numbers must be formed. In this case, it is believed that an approach of artifact metrics making use of randomness that may be generated in a production course of a medium, instead of an approach generated artificially, is effective, but courses in which randomness, instead of order, is generated must be selected in the production process. In a case of producing a medium material, for example, crystal growth is reconstruction of an order and is a course for eliminating randomness, which is contrary to the purpose. Representative disordering in material preparation is preparation of amorphous materials such as glass and plastics. However, amorphous materials are disordering at a molecular/atomic level, which cannot be observed when used in authentication because the unit is too small. In other words, it is necessary that an observable structural substance has been formed and the organization thereof is random.

Furthermore, stability of readout (Stability) also becomes a practically necessary condition. In other words, it must satisfy a property such that, when an artifact metrics element is read again after registration of the artifact metrics element, information equal to that at registration can be read stably. For this, a substance is preferable, which is not only observable but also in distinct contrast, for example, to give an image.

The Individuality and the stability of readout (Stability) are essential requirements as an authentication medium. Here, being readable imposes a limitation on observation manners. When an ordinary readout, an optical camera, a scanning microscope such as a scanning electron microscope, a laser microscope or an AFM, or the like is to be used, a unit of change in an individual structure is 10 nm or more, which is the lower limit of measurement manners. With respect to the upper limit, even if the largest size of a medium is limited to 1 cm square, the unit of variation of an individual structure must be changed at least in a plurality of units when variability of randomness is taken into consideration. Therefore, a too large variation unit is not preferred, and the unit is a structural substance unit of mm or less, and more preferably of 200 μm or less.

From the viewpoint of these, as a course in which randomness, instead of order, is generated in a production process, particles or an organized body brought together to some degree, instead of a unit of a molecule or an atom, are preferable. For example, disordering of a fiber structural substance is considered preferably, and nonwoven material such as paper based on fibers, which is a related art, is considered as an option. However, in papermaking or the like, ordering is also generated, and therefore disordering of a considerable degree is unlikely to occur.

### CITATION LIST

### Patent Literature

PTL 1: Japanese Patent Laid-Open No. 2002-226740
PTL 2: Japanese Patent Laid-Open No. S49-131142(1974)
PTL 3: Japanese Patent Laid-Open No. 2006-123174
PTL 4: Japanese Patent Laid-Open No. H10-049647(1998)
PTL 5: Japanese Patent No. 5292571
PTL 6: Japanese Patent No. 5263721
PTL 7: Japanese Patent No. 1617152 (Japanese Patent Publication No. H02-62503)
PTL 8: Japanese Patent No. 1757525 (Japanese Patent Publication No. H04-60936)
PTL 9: U.S. Pat. No. 216,744 (1938). H. P. Hood and M. E. Nordberg Non Patent Literature
NPL 1: H. Matsumoto, M. Une, T. Matsumoto, N. Iwashita and T. Sugahara, “Current Status and Issues in Evaluation of Artifact metrics”, Monetary and Economic Studies, Vol. 23, No. 1, pp. 61-140, Institute for Monetary and Economic Studies, Bank of Japan, June 2014
NPL 2: H. Matsumoto, I. Takeuchi, H. Hoshino, T. Sugahara, and T. Matsumoto, “An Artifact-metric System Which Utilizes Inherent Texture”, IPSJ Journal, 42 (8), pp. 139-152 (2001).
NPL 3: H. Matsumoto and T. Matsumoto, “Clone match rate evaluation for an artifact-metric system”, IPSJ Journal 44, pp. 1991-2001 (2003)
NPL 4: M. Yamakoshi, J. Tanaka, M. Furuie, M. Hirabayashi, and T. Matsumoto, “Individuality evaluation for paper based artifact-metrics using transmitted light image”, Proc. SPIE 6819, 68190H-1-68190H-10 (2008)
NPL 5: N. Yoshida, Y. Yokoyama, K. Nishimura and T. Matsumoto “Metallic-Foil Artifact Metrics”, The IEICE Transactions A, Vol. J99-A, No. 8, pp. 341-350 (August 2016)
NPL 6: T. Matsumoto, M. Hoga, Y. Ohyagi, M. Ishikawa, M. Naruse, K. Hanaki, R. Suzuki, D. Sekiguchi, N. Tate, M. Ohtsu, “Nano-artifact metrics based on random collapse of resist”, Scientific Reports 4, Article number: 6142 (2014)
NPL 7: M. Fujikawa, F. Oda, K. Moriyasu, S. Fuchi and Y. Takeda, “Study of New Artifact-metrics for Valuable Porcelain”, Computer Security Symposium 2013, 3D3-4 (October 2013)
NPL 8: K. Eguchi, “Use of Porous Glass”, Bulletin of the Japan Institute of Metals, Vol. 23, No. 12, pp. 989-995, 1984
NPL 9: K. Eguchi, “Manufacturing and applications of porous glasses”, Surface, Vol. 25, No. 3, pp. 184-194 (1987).
NPL 10: H. Tanaka, T. Yazawa, K. Eguchi, H. Nagasawa, N. Matuda, and T. Einishi, “Precipitation of colloidal silica and pore size distribution in high silica porous glass”, Journal of Non-Crystalline Solids 65 pp. 301-309 (1984)
NPL 11: H. Nagasawa, Y. Matumoto, N. Oi, S. Yokoyama, T. Yazawa, H. Tanaka, and K. Eguchi, “Effects of pore size on the retention time of octadescyl silanaized porous glass in high performance liquid chromatography”, Analytical Science, vol. 7 (Suppl) pp. 181-182 (1991)
NPL 12: H. Nagasawa, “Application to a sensor of the phase-separated method porous glass”, Chemical Sensors, Vol. 31, No. 1, pp. 10-20 (2015).
NPL 13: D. G. Lowe, “Object recognition from local scale-invariant features”, Proc. of the International Conference on Computer Vision, Corfu (September 1999)
NPL 14: Y. Sasaki, S. Konno, Y. Tsunekawa, “A Study of SURF Algorithm using Edge Image and Color Information”, The Society of Instrument and Control Engineers TOHOKU, 280th Workshop, No. 280-4, pp. 1-7 (2013)
NPL 15: Tohru NOBUKI, Synthesis of Laves phase related bcc alloys and their hydrogenation, Journal of Advanced Science, Vol. 19, No. 1&2, 2007

### SUMMARY OF INVENTION

### Technical Problem

Before now, as artifact metrics, systems in which paper, metal foil (aluminum foil), magnetic fiber or collapse of nanostructural resist is a subject, systems for authenticity determination of valuable ceramic wares, and the like have been proposed (for example, see Non-Patent Literature Nos. 2, 4, 5, 6, 7). However, they do not satisfy the above described requirements such as Stability, and, therefore, it is a major subject of this field to discover a material that satisfies the above-described four requirements. That is, it is the subject to find a material that satisfies the four requirements and, preferably, can be supplied stably and economically, and to establish a production method thereof to be applied to an authentication system.

### Solution to Problem

For the subject, spinodal decomposition and an associated spinodal phase separation structure have been considered as a solution. The spinodal decomposition means phase separation that corresponds to a change of state from an unstable state to an equilibrium state, and the phase separation takes place, for example, by quenching/holding an alloy or a polymer solution of a single phase at a temperature that gives a polyphasic region. Here, the state after the quenching is in a nonequilibrium state, and, when free energy G is defined, the state is classified into two types according to a sign of second-order differential of the free energy for a composition C. A plus state is called a metastable state. In this case, the free energy increases by concentration fluctuation, and nucleation is necessary for phase separation.

A minus state is an unstable state, and the free energy decreases by concentration fluctuation. That is, phase separation proceeds according to the growth of fluctuation, which is called a spinodal decomposition. Nucleation is unnecessary, and, even with small concentration fluctuation, concentration difference spreads by diffusion of atoms. A wave of concentration fluctuation grows with an increased rate at a specific wavelength, and, therefore, an organization generated by spinodal decomposition frequently presents periodically modulated structures. Moreover, in phase separation, occasionally there are a case where a droplet structure is formed (binodal phase separation), while a case where a continuous phase is formed to have a structure segmented into two intertwining phases, is especially called spinodal phase separation.

Substances that form the spinodal phase separation structure include monolayer alloys and polymer solutions. Further, as a substance having a typical structure of the spinodal phase separation structure, there is phase-separated method porous glass (porous glass). The spinodal phase separation structure has a certain periodicity, and is formed, for example in a case of porous glass, from two phases formed of different compositions shown in FIG. 1.

The organization generated by spinodal decomposition presents a periodical modulated structure, and a size unit of the modulated structure is comparatively large and is frequently not less than several tens in number of atoms. For example, in a case of phase-separated method porous glass that is of a representative spinodal phase separation structure, a size unit is from 10 nm to several tens μm, which is approximately an intended size.

Furthermore, the spinodal phase separation structure has following ideal structures as giving a randomness property in authentication.
The spinodal phase separation structure is a structure having periodicity, but the direction of continuous structure toward the subsequent period is random at every period and there is no regularity in a certain direction, unlike crystallization.
Accordingly, on the surface of a spinodal phase separation structure, characteristic points derived from the structure are generated at every period, and, when the surface is observed, characteristic points of at least square of N are generated in a region of square having N period length. Here, the reason of “at least” is that the number becomes larger when characteristic points at every period include not only branching but also a deformed member such as a variation.
Furthermore, a spinodal phase separation structural substance is a three-dimensional substance, and, when a three-dimensional randomness is taken into consideration, larger number of deformed members are formed.

From this, it is believed that a spinodal phase separation structural substance has sufficient possibility that satisfies Individuality required primarily for artifact metrics.

Furthermore, as an advantageous point of a spinodal phase separation structural substance, there is a feature that the period unit of periodicity can be controlled. For example, it is reported that, in the case of porous glass, the period unit can be controlled arbitrarily from 1 nm up to 100 μm. Accordingly, in the case of spinodal phase separation structural substances, recognition areas of different areas can be defined by changing the period unit. In the future, it is possible not only to provide many different authentication materials but also to prevent confusion of authentication of different areas by changing the period unit.

In addition, the fact of being a three-dimensional structure includes a possibility of two-dimensional image recognition, and, in the future, three-dimensional authentication will be practiced.

From the above-described reason, an individual authentication medium that is a fragment of a material having a spinodal phase separation structure and has at least one plane is designated as a material in individual authentication.

Examples of materials having a spinodal phase separation structure include alloys in metal materials (see, for example, Non-Patent Literature No. 15) and polymer solutions in organic materials (see, for example, Patent Literature No. 5). As an organic-inorganic composite material, there is sol-gel method porous glass having a spinodal phase separation structure (see, for example, Patent Literature No. 6), which is prepared utilizing a phase separation structure of polymer by containing polymer. Furthermore, there is phase-separated method porous glass (porous glass) as a substance having a typical structure.

Among these, spinodal phase separation structural substances formed from a solution of polymer that is an organic material is comparatively soft and has insufficient long term stability, and therefore it is hard to say that the substance is a material having excellent Stability preferable as a material in authentication.

A sol-gel method porous glass having spinodal phase separation structure, which is prepared from a polymer-containing material, is also a brittle material, and has some fault in Stability and, at the same time, has a property that cannot stand up to pollution by moisture and the like because of containing a skeleton as fine structure of fine pores formed of primary particles.

Furthermore, alloy-based spinodal phase separation structural substances have such possibility as malleability/ductility that are properties of metal and formation thereof into a minute medium has some difficulty.

However, among the same kind of spinodal phase separation structural substances, phase-separated method porous glass is a material that has high durability (Stability) and is unlikely to change, and has a preferable property as an authentication material. In addition, for the material, an accurate control of the pore diameter to an arbitrary pore diameter of from 1 nm up to 100 μm has already been established, and is a material as an authentication material available for measurement method using an electronic microscope and laser microscope or authentication using an optical microscope.

Consequently, as a preferable spinodal phase separation structural substance, an individual authentication medium formed of a phase-separated method porous glass that is prepared using a phase separation structure of borosilicate glass is a material in a more preferable individual authentication.

Here, when a property of phase-separated method porous glass as a spinodal phase separation structural substance is considered again, the condition of Individuality is satisfied more than enough because it is a spinodal phase separation structural substance, when the necessary condition as an artifact metrics is taken into consideration.

Moreover, the base material is a glass material, which is ideal in durability (Stability) because the material has heat resistance as high as several hundred degrees, is neither burnt nor molten, is excellent in weather resistance not to show degradation due to ultraviolet rays and the like, is not dissolved in almost all chemicals and organic solvents, and is firm physically.

Moreover, the structure formed of a pore part and a skeleton phase shows clear difference and, therefore, it is believed that not only the observation is allowed with a sufficient contrast by reflected light or transmitted light but also Stability can be secured over a long period of time because no deterioration occurs even by intense light.

Further, the raw material has fine structure based on glass and, therefore, it is very difficult to prepare an identical subject by directly processing another glass raw material. It is a three-dimensional substance and, therefore, it is difficult to make a copied substance as an authentication material including the three-dimensional structure. The periodic structure is controllable in spinodal phase separation, but the branched structure thereof is configured by a self-organized complex system/spontaneous generation and, therefore, cannot be copied as a matter of practice. Accordingly, it is believed to be a leading level also in Clone Resistance at the present time.

However, phase-separated method porous glass as prepared is basically a sponge-like structural substance of glass that is a transparent material and, therefore, there is some degree of difficulty in illumination and the like to acquire an image. With that background, for example, an authentication operation becomes easier by providing such processing as packing pores with a black filler or making the surface flat so that the observation becomes easy. Consequently, a preferable medium form is an individual authentication medium that has been subjected to at least one of processing of attaching a filler to pores of an individual authentication medium or processing of making the surface of an individual authentication medium flat, and that is formed of a phase-separated method porous glass having an arbitrary pore structure of an average pore diameter of 1 nm up to 100 μm.

Moreover, as a production method for an individual authentication medium, a production method including a raw material-mixing step, a fusion step, a molding step, a phase separation step, a chemical treatment step and a stabilizing step by resin sealing or the like has been devised. The raw material-mixing step mixes raw materials of glass. The fusing step fuses mixed materials to prepare a borosilicate glass host material. The molding step molds the prepared borosilicate glass host material. The phase separation step subjects the molded borosilicate glass host material to heat treatment to thereby conduct phase separation. The chemical treatment step gives a chemical treatment to the phase-separated borosilicate glass host material to prepare porous glass. Then, the prepared porous glass can be stabilized by resin sealing or the like.

In FIG. 2, an individual authentication system utilizing the individual authentication medium is exemplified. The individual authentication system and apparatus include an individual authentication medium, a data processor, and an observation device connected to the data processor. The individual authentication medium may be the above-described individual authentication medium. The observation device can acquire a surface image of the individual authentication medium and send the image to the data processor. The data processor can check information of characteristic points calculated from the surface image against information of characteristic points of the individual authentication medium having been stored in advance in a database, to thereby conduct individual authentication.

### Advantageous Effects of Invention

A case where the invention described in Claim is applied to a smartphone as a representative network device is considered. For example, a substance is assumed, in which a resin-sealed porous glass having 50 μm in pore structure, 100 μm in thickness and 8 mm*8 mm*1.1 mm (FIG. 3) is attached to a smartphone. The smartphone is set so that connection to the internet is not allowed in a state of not having the authentication material. A carrier possesses the image information of the porous glass medium for authentication as a database. When the device is to be authenticated on the internet,
1, for example, the carrier designates several divisions on the medium and requires the image information thereof. For the requirement, the device side sends the image information and receives authentication,
2, in a case of the use for important authentication, for example, in a case where the smartphone is functioned as an authentication device at ATM of a bank, the artifact metrics itself is put over a sensor possessed by the ATM side and image recognition is conducted to conduct authentication.

Meanwhile, it is considered that an authentication medium to be attached to an individual device is exactly only one and, for example, when a smartphone is stolen, the use of it without the agreement of the proper owner becomes almost impossible. That is, if someone steals a device and tries to utilize it, as a matter of course, attaching of the authentication medium is necessary and, when the authentication medium and the device are tied perfectly in one-to-one correspondence, actual theft becomes impossible.

In the same way, when an automatic driving car is assumed, individual authentication is always conducted strictly and, therefore, hijack etc. of driving becomes impossible and safe control from cyberterrorism becomes possible.

Furthermore, by performing link and strict tie to biometrics being identification of individual person, the safety of security of net banking and the like is enhanced remarkably.

In addition, in IoT, an individual number must be given to all devices and cards without duplication. In the case of the present invention, not only it is possible to devise for preventing overlapping by giving authentication pattern while performing classification such that a 50 μm pattern is for mobile phones and a 10 μm pattern is for household electrical appliances, but also it is possible to assign spontaneously random numbers while eliminating artificial deviation there.

Meanwhile, if a clone of medium information such as an image has been prepared by some techniques, it is considered to practice further deep individual authentication by three-dimensional structure.

Moreover, when authentication is to be practiced, authentication by a technique such as electromagnetic or CT scanning is also possible by packing pores of porous glass with a dielectric material, metal member or the like, in addition to image acquisition as described above.

As described above, in the individual authentication according to the present invention:
I. The branched structure of pores in the phase-separated method porous glass is configured randomly, and shows a high degree of randomness in utilizing the glass as artifact metrics.
II. The scaling of the branched pore structure from 10 nm up to 100 μm can be controlled and, therefore, the glass can be utilized for authentication of a wide range of accuracy in artificial metrics.
III. The phase-separated method porous glass is physically robust and, therefore, has practically sufficient Stability, and may be incorporated with a natural form into various devices (such as a smartphone) and sensors, because it is a glass material.
IV. To produce the phase-separated method porous glass, a high level of expertise is required, but production cost is inexpensive and, therefore, the glass may be incorporated inexpensively into various devices and sensors.

From this, the individual authentication medium of the present invention may be applied to various cards and testimonials such as a passport in the future.

Moreover, in addition to the above, it is believed that preparation of a clone becomes more difficult when the scaling of the pore structure of porous glass is made smaller, and difficulty in producing a clone is also expected.

### BRIEF DESCRIPTION OF DRAWINGS

FIG. 1 is a scanning electron microscope photograph of representative porous glass of an embodiment of the present invention, which is a photograph that shows three kinds of porous glasses having different pore diameters have similar structures;

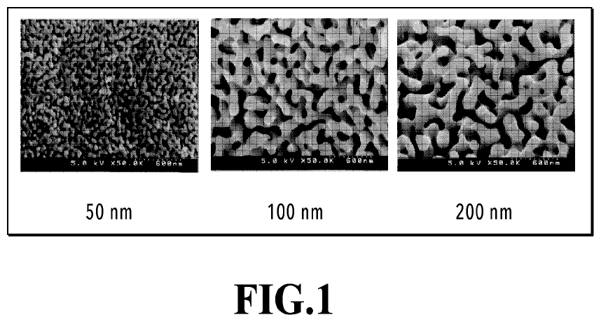

FIG. 2 is a schematic diagram of an evaluation apparatus of an embodiment of the present invention;

FIG. 3 is a photograph of appearance of a porous glass medium of an embodiment of the present invention (8 mm*8 mm*1.1 mm);

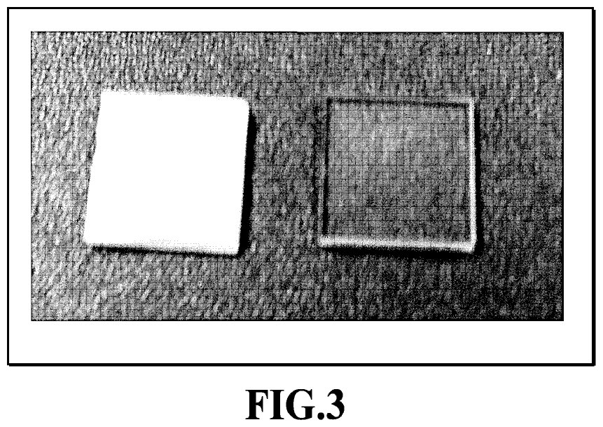

FIG. 4 is a diagram showing a production process of a porous glass medium of an embodiment of the present invention;

FIG. 5 is a scanning electron microscope photograph of porous glass having pore diameter of 200 nm used for evaluating an embodiment of the present invention;

FIG. 6 is a graph of FAR and FRR of 1-MNN: in a case where measurement is performed at the shortest distance (n=1), of an embodiment of the present invention;

FIG. 7 is a graph of FAR and FRR of 10-MNN: in a case where 10 distances are obtained in ascending order and measurement is performed by an average thereof (n=10), of an embodiment of the present invention; and

FIG. 8 is a graph of FAR and FRR of 100-MNN: in a case where 100 distances are obtained in ascending order and measurement is performed by an average thereof (n=100), of an embodiment of the present invention.

### DESCRIPTION OF EMBODIMENTS

### (Production Method)

Hereinafter, there will be explained in more detail a preparation method and characteristics of a material in individual authentication using this phase-separated method porous glass. “Glass” is an inorganic material having an amorphous network, and can be seen as an amorphous material that is antithetical to “systematization” or “ordering”, as a material representative of “disorder,” from the viewpoint of atom/molecule of an angstrom level. On the other hand, from the viewpoint of nano or larger levels, it can be understood as a uniform raw material.

Glasses that we usually see include “soda-lime glass,” “lead glass,” “borosilicate glass,” and “quartz glass.” “Soda-lime glass” is the most common glass formed mainly of three components of silicic acid, sodium oxide and calcium oxide. “Lead glass” is a glass having lead oxide as main component, and is known as a crystal glass. “Borosilicate glass” is a glass also referred to as a laboratory glass. “Quartz glass” is a glass formed from silicic acid alone.

Among these, borosilicate glass that has a low expansion coefficient, high heat shock resistance and very excellent chemical stability shows a phenomenon that it suddenly becomes chemically weak and tends to crack when used under a specific condition, which was formerly known as “borate anomaly.” On the basis of a fact that the cause of this was a phenomena referred to as “phase separation” of glass and expensive quartz glass could be prepared inexpensively if this phenomenon was used efficiently, synthesized quartz glass: Vycor glass was invented by Corning Incorporated, USA, in 1934. Then, as an intermediate, phase-separated method porous glass was invented.

As the phase-separated method porous glass, there are reported that of a high silicic acid type of SiO2: 96% or more in the final component, and that of a borosilicic acid type containing alumina or zirconia. These two kinds have different ranges of pore diameters to be prepared, that is, for high silicic acid type: 1 nm-300 nm, and for borosilicic acid type: 200 nm-50 μm.

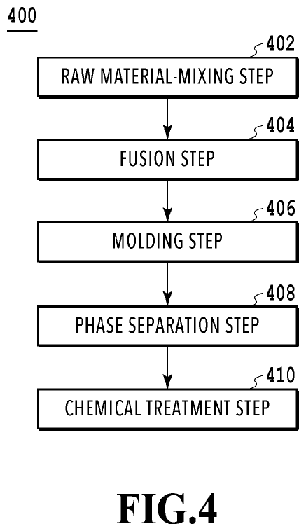

Referring to FIG. 4, a preparation process of high silicic acid type porous glass is shown below.
In a raw material-mixing step 402, raw materials are mixed using silica sand and borax, boric acid and sodium carbonate, alumina etc.
In a fusion step 404, raw materials mixed in the raw material-mixing step 402 are fused at around 1200° C.-1500° C. to prepare a borosilicate glass host material having SiO₂, B₂O₃ and Na₂O as main components.
In a molding step 406, the borosilicate glass host material prepared in the fusion step 404 is molded at around 800° C.-1100° C.
In a phase separation step 408, the borosilicate glass host material molded in the molding step 406 is subjected to a heat treatment, in which it is held at a temperature of a glass transition point or higher, to bring about phase separation. On this occasion, when the borosilicate glass host material is exposed to a temperature of a glass transition point or higher, respective component atoms fluctuate in the inside and begin to move. This phenomena closely resembles crystallization, but the glass keeps an amorphous state and is separated into two glass phases that take more stable states at the temperature, and, while fine atomic arrangement keeps a random amorphous phase, an ordered structure is formed as a somewhat macro cluster.

In the two phases, one is a silica phase formed of almost silicic acid, and the remnant is a sodium borate phase formed of boric acid, sodium oxide and silicic acid. On this occasion, depending on a composition and temperature of starting glass, there is a case where a spinodal structure, in which organization is intertwined such as sponge, is formed, and a case where a droplet structure, in which one phase is isolated such as a liquid drop, is formed. Porous glass is obtained from a spinodal phase-separated substance that has a continuous phase structure.

When continuously exposed to certain or higher temperature in a state separated into two phases, these two phases bring about rearrangement and an ordered structure grows. Meanwhile, when temperature exceeds a range in which the phase separation is brought about, the glass returns again to homogeneous composition. It is possible to consider that this phase separation phenomenon is a phenomenon in which component molecules composing glass repeat self-assembly and dissipative structure for stabilization, and that two phases that are most stable at the temperature self-organize toward a direction in which an interfacial area is minimized. This is pattern formation due to spinodal phase separation of a liquid, and is structure formation, which can be taken out by freezing the liquid due to self-organization, because a reaction of glass has an extremely long time axis.

A characteristic of structure formation due to spinodal phase separation is ordering in a macro view point, but it is believed that, unlike crystal growth, random formation in order formation is included, and that a structure formed of many branched structures are all different although in similar figures. Elaboration of a pore structure by control from an outside can control pore diameter, but cannot give control of a branched structure. Moreover, this structure can also give random structures of various modes by varying the pore diameter.

In the random structure due to phase separation, randomness appears without exception on the basis of a distance unit shown by pore diameter, and, as a consequence of generation of subsequent randomness on the basis of subsequent distance unit, finally a high degree of randomness is achieved.

A spinodal structure of porous glass gives a complex structure of two-dimension from the viewpoint of surface and of three-dimension as an overall structure. A phase separation structure is determined by factors of temperature and time period, and properties of porous glass to be prepared is different when temperature is different even under conditions that give the same structure, but, because they have similar figures, dissimilarity thereof is not distinct apparently, which is also a characteristic.

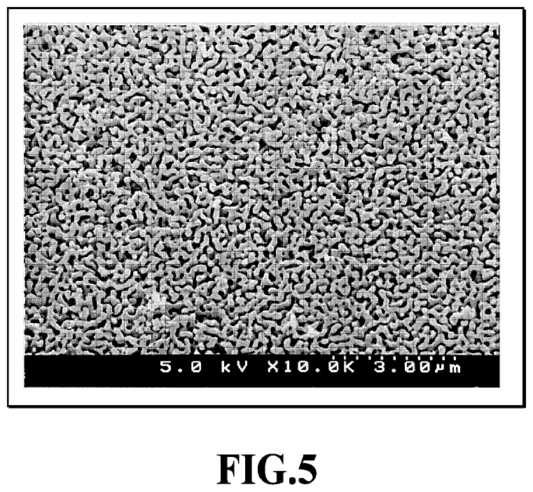

In a chemical treatment step 410 in FIG. 4, the borosilicate glass host material phase-separated in the phase separation step 408 is subjected to a chemical treatment using an acid solution. Usually, several-normal sulfuric acid or nitric acid is used, which is held at 90° C. or higher to elute a sodium borate phase. After the end of the treatment, and water-wash and drying, an A type porous glass of SiO2: about 96% shown in FIG. 5 is obtained.

A pore structure of the A type porous glass does not reflect a phase separation structure, and actually is a structure in which silica gel originating in a sodium borate phase accumulates in a skeleton structure formed of silica glass. Furthermore, in the chemical treatment step 410 in FIG. 4, a B type porous glass reflecting the phase separation structure is obtained by removing the silica gel in some way, such as removal thereof with an alkali aqueous solution.

Furthermore, as to characteristics of this porous glass, a skeleton supporting the structure is glass, which is firm and solid, and the glass is unlikely to break as compared with ordinary glass because strain has been eliminated in phase separation, to give a firm material mechanically and chemically. Furthermore, after a chemical treatment has been performed once to result in porous glass, phase separation does not continue to give a material that is stable thermally too.

In the above-described production method, main raw materials are silicic acid (silica sand), boric acid, sodium carbonate, alumina, zirconia, etc., which are the same as those of ordinary borosilicate glass and therefore the material costs are not expensive.

Moreover, the production process includes mixing of raw materials, fusion, molding, phase separation, and chemical treatment, and equipment necessary for the production is a mixer, fusion crucible, electric furnace (air atmosphere), chemical treatment reactor (level of flask), and particularly expensive equipment is unnecessary, but price of porous glass at this time is high. However, this is mainly due to process costs, and is mainly due to labor cost in small-lot production. Furthermore, processing of porous glass is not different from ordinary glass processing, and facilities and procedures having been established already can be utilized. Porous glass may easily be supplied in a mass scale, if needed. Phase-separated method porous glass to be prepared in this way is finished as a medium, for example, of 1 mm square and 50 μm in thickness, is stabilized by resin sealing or the like, and is fixed firmly to a target.

(Specific Authentication Method)

An authentication system that realizes artifact metrics is referred to as an artifact metric system (see, for example, Non-Patent Literature No. 2). Here, an artifact metric system is configured basically of following two phases.
Registration phase: to register a target artifact, data representing characteristics thereof (randomness) (hereinafter, referred to as registration data) are acquired with a sensor and are recorded in a database.
Verification phase: to perform authentication of a target artifact, data representing characteristics thereof (hereinafter, referred to as verification data) are acquired with a sensor. Then, using the verification data, and registration data recorded in the database, verification is performed and, finally, a verification result (acceptable or rejectable) is output.

A purpose of the artifact metric system is to determine whether or not an artifact presented in the registration phase and an artifact presented in the verification phase are the same substance. When they are determined to be the same, “acceptable” is output, and when they are determined to be not the same, “rejectable” is output. As indices for objectively measuring basic accuracy of an artifact metric system, following FAR (or FMR: False Match Rate) and FRR (or FNMR: False Non-Match Rate) are known.
FAR (False Acceptance Rate): probability that different artifacts are erroneously determined to be acceptable.
FRR (False Rejection Rate): probability that the same one artifact is erroneously determined to be rejectable.

Above-described two kinds of error probability (the error probability that false is determined as true, and the error probability that true is determined as false) are not limited to artifact metric systems. These can be considered generally in all authentication systems (such as a biometric system), determination systems and testing systems (such as a hypothesis testing), and are indices for measuring basic accuracy of these systems.

Moreover, as an index for measuring enhanced security for an artifact metric system, the following index is known (see, for example, Non-Patent Literature No. 3).
CAR (Clone Acceptance Rate): probability of erroneous acceptance of clone, which is a false artifact

Comprehensive analysis of CAR for producibility of all clones is generally difficult, but it would be desirable to analyze CAR as widely as possible.

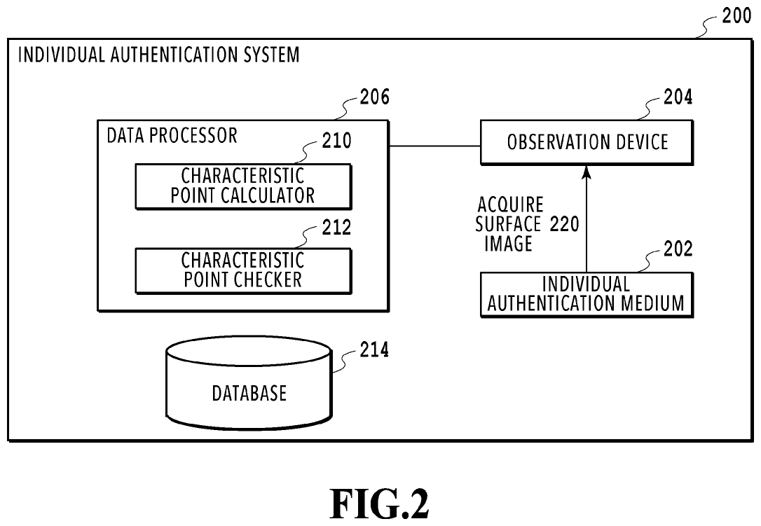

An embodiment of an individual authentication system 200 is shown in FIG. 2. The individual authentication system 200 includes an individual authentication medium 202, a data processor 206 and an observation device 204 connected to the data processor. In authentication, in advance, characteristic information on an image in the individual authentication medium 202 is registered for a database 214. In individual authentication, the observation device 204 acquires a surface image of the individual authentication medium 202 in 220. The observation device 204 sends the acquired surface image to the connected data processor 206. The data processor 206 can be equipped with a characteristic point calculator 210 that calculates characteristic points from the surface image received from the observation device 204. In addition, it can be equipped with a characteristic point checker 212 that checks calculated characteristic points against characteristic point information of the individual authentication medium 202 having been registered in advance for the database and practices authentication.

Here, the observation device 204 can be any device such as an optical camera, scanning microscopes such as a scanning electron microscope, laser microscope or AFM, or the like. The data processor 206 can be any equipment such as a server and personal computer (PC). Moreover, the characteristic point calculator 210 can include any calculation technique.

However, to perform this work operation for all authentication is accompanied with measurement, and therefore it is considered, except for performing absolute authentication, usually to construct a system in which digital information to be acquired from an image is registered for a device and the information therein is to be checked.

In other words, in this authentication system, a huge number of random information is included in the phase-separated method porous glass being artifact metrics, and therefore it is possible to consider this as a table of random numbers given from nature. Then, ordinary authentication can be practiced with extremely high stability by giving randomly a part of porous glass information possessed by the device side in accordance with request from a checker.

Meanwhile, in absolute authentication, the use of access to artifact metrics itself is preferred. That is, this authentication system is configured of an individual authentication system and devices that authenticate individuality by acquiring an image on the surface of the individual authentication medium with an optical camera, a scanning microscope such as a scanning electron microscope, laser microscope or AFM, or the like and using characteristic point information of the image. It is possible to use an individual authentication system and devices matched with a material as a consequence of selection in accordance with a security level requested by the various observation systems as described above.

### Example 1

According to phase-separated method porous glass of a borosilicic acid type described in Patent Literature Nos. 7, 8, six plate-like substances having pore diameter of 200 nm are prepared. Then, on the basis of images obtained by observing each with a scanning electron microscope (SEM) at magnifications of 5,000 and 10,000, a simple experiment for examining randomness of distribution of pores in porous glass was performed.

For determining match/unmatch of distribution pattern of pores relative to the image of porous glass, a technique on the basis of pattern matching using an amount of characteristics was utilized. Details thereof will be explained in the following paragraph or later.

### (Preparation of Porous Glass and Method for Acquiring Image)

As a sample, typical borosilicic acid type porous glass (average pore diameter; 200 nm) was prepared, and the different eight sites were photographed with a SEM (magnification: 10,000) to give eight original images I, II, . . . , VIII (hereinafter, these are referred to as parent images). In the same way, the same eight sites were photographed with a SEM at a changed magnification (magnification: 5,000) to give additional eight original images i, ii, . . . , viii (hereinafter, these are referred to as child images). Here, there is assumed a case where accuracies when an image is acquired are different between a registration phase and verification phase in an artifact metric system. To examine whether or not verification functions effectively even under a bad circumstance such as different accuracies of sensors for acquiring an image, images of varied magnifications were set as experiment objects. For example, it was considered that the parent image was registration data, and the child image was verification data.

### (Verification Method in Artifact Metric System)

As a verification method for the parent image and the child image, a technique on the basis of pattern matching utilizing a Sift characteristic amount was utilized. Here, Sift (Scale-Invariant Feature Transform) (see, for example, Non-Patent Literature No. 6) is a method for characteristic point detection and description thereof presented by D. Lowe in 1999. Sift is characterized in that it never changes regardless of rotation or scale change of an image and is resistant to change in illumination. Sift is a characteristic amount detecting technique that is installed in OpenCV, which is an image processing library of open source, and is widely used in image discrimination etc. Furthermore, in verification of the parent image and the child image, an approach with a local characteristic amount is also utilized. Here, the local characteristic amount is an amount obtained by detecting a point having highly contrasting density of image and expressing differentiation relative to the circumference thereof with a vector (see, for example, Non-Patent Literature No. 11).

Characteristic amounts obtained by above-described method for any combination of the parent image and the child image are compared in a round robin manner, and a pair of characteristic points with the smallest difference d is found out, and the d is set as a distance. After that, the distances d are compared for all target pairs, n distances d were selected in ascending order, and an average thereof was defined as distance between both images. On the basis of this, pattern matching between the parent image and the child image was performed, in which, as values of the n, following three kinds were set to targets of examination.
1-MNN: a case where measurement is performed by the smallest distance alone (n=1)
10-MNN: a case where ten distances are obtained in ascending order and measurement is performed by an average thereof (n=10)
100-MNN: a case where hundred distances are obtained in ascending order and measurement is performed by an average thereof (n=100)

Utilizing distances of examination targets, a case where a distance between both images (parent image and child image) being targets is less than a certain value (hereinafter, referred to as a threshold) is determined to be acceptable, and a case where a distance is equal to or more than the threshold is determined to be rejectable.

### (Results of Experiments)

With respect to parent images I, II, . . . , VIII and child images i, ii, . . . , viii, values of distances (round down to the nearest decimal) on the basis of 1-MNN are shown in Table 1.

TABLE 1

| | I | II | III | IV | V | VI | VII | VIII |
|---|---|---|---|---|---|---|---|---|
| i | 11 | 109 | 159 | 184 | 206 | 228 | 231 | 222 |
| ii | 110 | 16 | 153 | 175 | 195 | 185 | 241 | 221 |
| iii | 167 | 171 | 17 | 230 | 240 | 225 | 245 | 232 |
| iv | 143 | 162 | 221 | 15 | 233 | 218 | 224 | 225 |
| v | 120 | 134 | 234 | 179 | 17 | 213 | 234 | 248 |
| vi | 181 | 202 | 207 | 214 | 201 | 19 | 241 | 221 |
| vii | 247 | 190 | 236 | 232 | 246 | 236 | 15 | 236 |
| viii | 239 | 221 | 246 | 231 | 230 | 226 | 240 | 19 |

In Table 1, values lying at diagonal elements designate the same photographing site in the porous glass, and therefore are distance values of cases to be determined as acceptable, and the others are distance values of cases to be determined as rejectable. Here, all values lying at diagonal elements are less than 20, while the other values are equal to or more than 100. As a consequence, a highly unique property of the image can be confirmed, and this shows that randomness of distribution of pores in the porous glass is high.

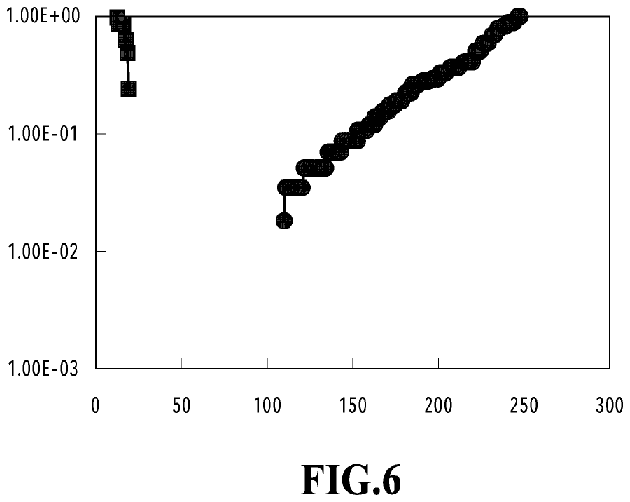

FIG. 6 is a graph of FAR and FRR in the case of 1-MNN. Here, the abscissa axis in FIG. 6 represents a “threshold of distance,” and the ordinate axis represents an “error probability.” In FIG. 6, total 64 distances, that is, 8 parent images by 8 child images, are calculated to draw the graph. This result is believed to show good accuracy with respect to 64 experimental data. If the difference between magnifications of the parent image and the child image is almost the same, furthermore high accuracy would be represented, as compared with this experimental result. In this description, as the first experiment of a case where a porous glass is applied to artifact metrics, the experiment was performed with a small number of experimental data, in the presence of difference in accuracy of sensors acquiring registration data and verification data, and according to a scenario assuming a simple verification method. Nevertheless, it is believed that the experiment result shows good accuracy. Therefore, it is believed that porous glass can be expected as an application material to artifact metrics.

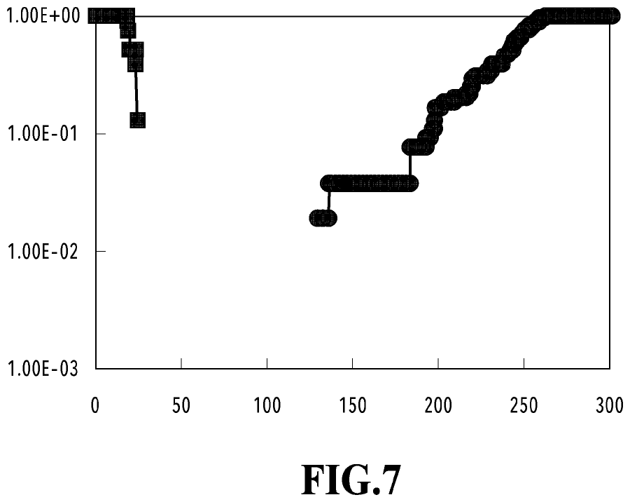

FIG. 7 is a graph of FAR and FRR in the case of 10-MNN. Here, the abscissa axis in FIG. 7 represents a “threshold of distance,” and the ordinate axis represents an “error probability.” In FIG. 7, total 64 distances, that is, 8 parent images by 8 child images, are calculated to draw the graph.

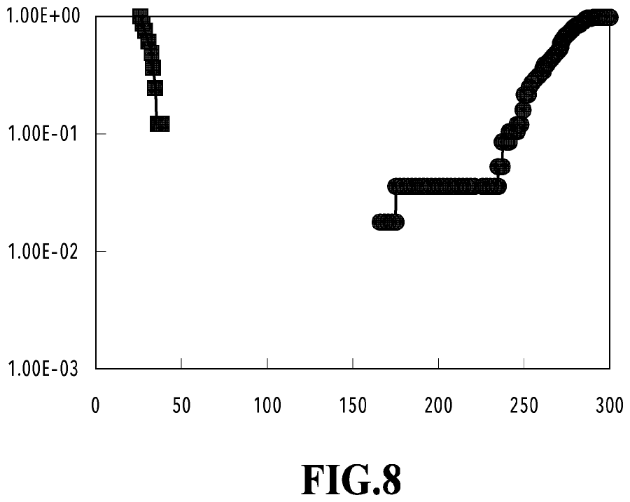

FIG. 8 is a graph of FAR and FRR in the case of 100-MNN. Here, the abscissa axis in FIG. 8 represents a “threshold of distance,” and the ordinate axis represents an “error probability.” In FIG. 8, total 64 distances, that is, 8 parent images by 8 child images, are calculated to draw the graph.

The embodiment described in the present description and drawings is an example, and should not be construed as limitation or restriction for the attached Claims.

### INDUSTRIAL APPLICABILITY

The present invention relates to individual authentication that is needed in practice of network environment and credit acts such as various commercial transactions and contracts in explosive spread of mobile devices or in an IoT community. In particular, for various computers, mobile phones, machineries such as automobiles and cards (artifact) that are used in social acts such as economic acts, which do not have sure individual identifiability at this time, artifact metrics having spinodal phase separation structure prepared as self-organization can be utilized. Consequently, it becomes possible to give an ultimate individual authentication system. Moreover, by cooperating with biometrics identifying an individual person, forgery and falsification are made difficult. Furthermore, network systems for performing individual identification, including dishonest act become easily discriminated, authentication can be performed with improved accuracy, and a safe network environment at low cost.

1. An individual authentication medium, the medium being a fragment of a material possessing a spinodal phase separation structure and having at least one flat surface.

2. The individual authentication medium according to claim 1, the medium being formed of a phase-separated method porous glass prepared by using a phase separation structure of borosilicate glass.

3. The individual authentication medium according to claim 1, the medium having been subjected to at least one of processing for attaching a filler to pores of the individual authentication medium or processing of smoothing the surface of the individual authentication medium, and being formed of a phase-separated method porous glass having an arbitrary pore structure having an average pore diameter of 1 nm up to 100 μm.

4. The individual authentication medium according to claim 2, the medium having been subjected to at least one of processing for attaching a filler to pores of the individual authentication medium or processing of smoothing the surface of the individual authentication medium, and being formed of a phase-separated method porous glass having an arbitrary pore structure having an average pore diameter of 1 nm up to 100 μm.

5. A method for producing an individual authentication medium, comprising: a raw material-mixing step of mixing raw materials of glass; a fusion step of fusing the mixed materials to prepare a borosilicate glass host material; a molding step of molding the prepared borosilicate glass host material; a phase separation step of conducting phase separation by subjecting the molded borosilicate glass host material to a heat treatment; a chemical treatment step of subjecting the phase-separated borosilicate glass host material to a chemical treatment to prepare porous glass; and a step of conducting stabilization by resin sealing and the like

6. An individual authentication system including:
an individual authentication medium that is a fragment of a material possessing a spinodal phase separation structure and has at least one flat surface;
a data processor; and
an observation device connected to the data processor,
and: configured such that;
the individual authentication medium is the individual authentication medium according to claim 1;
the observation device acquires a surface image of the individual authentication medium and sends it to the data processor; and
the data processor checks calculated characteristic point information against characteristic point information of the individual authentication medium, having been registered in advance for the database, and practices the individual authentication.

7. The individual authentication system according to claim 6, wherein the individual authentication medium is formed of a phase-separated method porous glass prepared using a phase separation structure of borosilicate glass.

8. The individual authentication system according to claim 6, wherein the individual authentication medium has been subjected to at least one of processing for attaching a filler to pores of the individual authentication medium or processing of smoothing the surface of the individual authentication medium, and is formed of a phase-separated method porous glass having an arbitrary pore structure having an average pore diameter of 1 nm up to 100 μm.

9. The individual authentication system according to claim 7, wherein the individual authentication medium has been subjected to at least one of processing for attaching a filler to pores of the individual authentication medium or processing of smoothing the surface of the individual authentication medium, and is formed of a phase-separated method porous glass having an arbitrary pore structure having an average pore diameter of 1 nm up to 100 μm.
